(19) United States
(12) Patent Application Publication
(10) Pub. No.: US 2011/0202649 A1
(43) Pub. Date: Aug. 18, 2011

(54) USER-CENTRIC LAYERED SERVICE DELIVERY PLATFORM FOR ENABLING I-CENTRIC SERVICES AND SERVICE PROVIDING METHOD USING THE SAME

(75) Inventors: Won Ryu, Daejeon-city (KR); Changwoo Yoon, Daejeon-city (KR); Bong Tae Kim, Daejeon-city (KR); Chieteuk Ahn, Daejeon-city (KR)

(73) Assignee: Electronics and Telecommunications Research Institute, Daejeon-city (KR)

(21) Appl. No.: 13/120,597

(22) PCT Filed: Sep. 23, 2009
(86) PCT No.: PCT/KR2009/005430

§ 371 Date: Mar. 23, 2011

(30) Foreign Application Priority Data
Sep. 23, 2008 (KR) 10-2008-0093389

(51) Int. Cl. G06F 15/173

(52) U.S. Cl. 709/223

(57) ABSTRACT

An apparatus for providing I-centric services using a service delivery platform which is user-centric layered and a service providing method using the same are provided. The apparatus includes a media service platform providing an enabler obtained by abstracting resources and an I-centric enabler, a service creation environment providing a layered service creation and execution environment for each user, and a service execution environment. A personal user, a third party service provider and a service provider can create and provide various personalized services using the media service platform, the service creation environment and the service execution environment.

### TECHNICAL FIELD

The present invention relates to a service delivery platform (SDP), and more particularly, to an apparatus for providing I-centric services using a user-centric layered SDP capable of supporting diversification, convergence and personalization of services to provide convergence services such as IPTV easily and quickly in the rapidly changing information communication environment and a service providing methods using the same.

This application claims the benefit of Korean Patent Application No. 10-2008-0093389, filed on Sep. 23, 2008, in the Korean Intellectual Property Office, the disclosure of which is incorporated herein in its entirety by reference.

### BACKGROUND ART

Previously, when only wired and wireless telephones existed in the communication environment, network operators or service providers generated and provided services and the number of generated services was small. A collective system for executing a service, such as a service providing system or a service/user management system, was constructed for the service whenever needed.

The current service environment in which circuit-based communication is changing to Internet-centric packet-based communication and wired and wireless communications are integrated, the number of services required to be developed and provided to users geometrically increases and the lifetime of services is shortened to require services to be developed within a short period. Furthermore, with the rapid development of information technology such as web technology, there is a need to integrate information, communication and broadcasting technologies to create new convergence services. Moreover, users want to receive services only for themselves and act not only as service consumers but also service prosumers with the spread of various personal devices.

A service delivery platform (SDP), a technique developed to meet this variation in communication and information technology environments, such as CSF of MS, CS Gatekeeper of Oracle, allows common carriers to rapidly create and deliver services to efficiently provide the services and assist third party service providers or personal information providers in participating in service business.

### DISCLOSURE OF INVENTION

### Technical Problem

Conventional techniques relating to the SDP mostly define the SDP as a set of enablers corresponding to abstract forms of physical devices of a network or the Internet. These conventional techniques provide general SDP structures in which service common functions such as an operation support system (OSS)/business support system (BSS) are connected with the enablers of the SDP to enable rapid service creation and to enable third party service providers and users to abstract functions to create and provide services even if they are not network operators.

Furthermore, in terms of creation of services through a personalized service providing method and a graphic user interface (GUI), the conventional techniques use a general GUI utilization method for service description or limit the description range to web portals and define a service only as a set of components.

### Technical Solution

The present invention provides a service delivery platform structure and method for supporting circumstances in which users can be service providers as a service environment is personalized to meet a demand for service personalization and supporting a service structure in which third party service providers and users are included in a service business model.

The attached drawings for illustrating preferred embodiments of the present invention are referred to in order to gain a sufficient understanding of the present invention, the merits thereof, and the objectives accomplished by the implementation of the present invention. Furthermore, it will be easily understood that the objectives and merits of the present invention can be accomplished according to means and combinations thereof described in the appended claims.

### Advantageous Effects

The present invention provides a service delivery platform for rapidly creating and spreading a large quantity of services with the diversification, convergence and personalization of services. Personal user, third party service providers and service providers can create and provide a variety of personalized services through embodiments of the present invention and construct a business model (BM) from the created services and service function elements represented as enablers to make a profit.

The service delivery platform of the present invention operates on the server, e.g. computer, can create a variety of personalized services as compared to a conventional service delivery platform and provide a layered service creating/executing method according to personal ability to use or create services to present a solution for personalization/convergence of services. Moreover, the present invention represents various physical elements such as communication elements, information description elements and knowledge elements as standardized abstracted objects (enablers and components) and uses the enablers and components to create layered services to present a solution for service diversification.

### DESCRIPTION OF DRAWINGS

The above and other features and advantages of the present invention will become more apparent by describing in detail exemplary embodiments thereof with reference to the attached drawings in which:

FIG. 1 is a conceptional view illustrating an internal configuration of a service delivery platform for providing I-centric services, according to an embodiment of the present invention;

FIG. 2 illustrates a structure for describing a process of generating a new convergence enabler using enabler, according to an embodiment of the present invention;

FIG. 3 is a flowchart illustrating a process of generating a new convergence enabler using enablers, according to an embodiment of the present invention;

FIG. 4 illustrates a structure of a user-centric layered service creation environment according to an embodiment of the present invention;

FIG. 5 illustrates I-centric services that can be provided by the service creation environment of FIG. 4, according to an embodiment of the present invention; and

FIG. 6 is a flowchart illustrating a process of generating an I-centric service, according to an embodiment of the present invention.

### BEST MODE

According to an aspect of the present invention, there is provided an apparatus for enabling I-centric services using a service delivery platform, which includes a media service platform providing an enabler obtained by abstracting physical resources, an I-centric enabler obtained by abstracting a user, and a common interface of enablers, a service creation environment layered according to service creating subjects and allowing a user or a service provider to create services using the enabler, and a service execution environment storing the created services and executing I-centric services based on a user profile in operative connection with the media service platform.

According to another aspect of the present invention, there is provided a method of creating an I-centric service using a service delivery platform, which includes accessing a service creation environment layered according to service creating subjects to create a service, requesting a service provider to create a new enabler when an enabler that is obtained by abstracting physical resources and constructs a service does not exist, and creating the service using the new enabler.

According to another aspect of the present invention, there is provided a method of generating an enabler for creating an I-centric service, which includes combining a component corresponding to a minimum element of a service and an enabler corresponding to a set of connected components in a media service platform that provides the component and the enabler to create a new enabler, and dynamically applying and adding the new enabler to the media service platform.

### MODE FOR INVENTION

In the following detailed description, only certain exemplary embodiments of the present invention will be described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word ‘comprise’ and variations such as ‘comprises’ or ‘comprising’, will be understood to imply the inclusion of stated elements but not the exclusion of any other elements. Each of the described components means a unit of processing at least one function or operation and can be implemented by hardware, software or a combination of hardware and software.

The present invention will now be described more fully with reference to the accompanying drawings, in which exemplary embodiments of the invention are shown.

While a conventional service delivery platform supports only service diversification and convergence, the present invention efficiently supports not only service diversification and convergence but also personalization services. To achieve this, the present invention provides a service delivery platform including a media service platform (MSP) that provides resource abstraction enablers and I-centric enablers, a service creation environment (SCE) and a service execution environment (SEE) that provide layered service creation and execution environments for each user.

The service creation environment of the present invention has a service user-centric layered service creation structure. Service providers who possess physical network elements can use all the functions of the service creation environment. However, actual service users require to consider services from a point of view of abstraction of devices belonging to them or services without understanding complicated network function elements. Accordingly, the present invention provides a layered service creation environment in which users create services using only functions abstracted for each service.

The media service platform of the present invention represents physical resources as connection of enablers and components in standardized forms. A component is the minimum unit of a physical element function and a set of connected components defines an enabler. Furthermore, an I-centric enabler is defined to describe I-centric services.

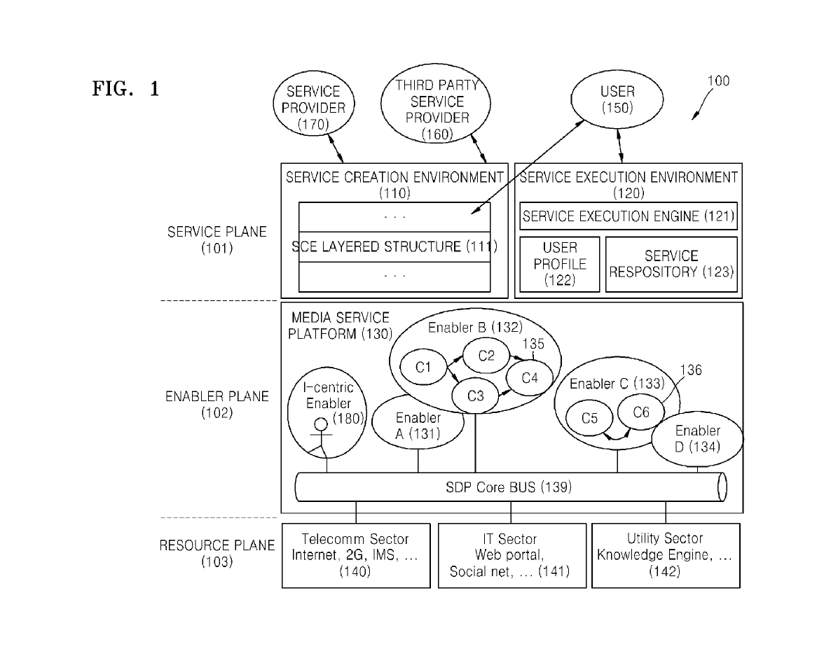

FIG. 1 is a conceptional view illustrating an internal configuration of a service delivery platform 100 for providing I-centric services, according to an embodiment of the present invention.

Referring to FIG. 1, the service delivery platform 100 according to the embodiment of the present invention includes a service creation environment 110, a service execution environment 120 and a media service platform 130.

The service delivery platform 100 has independent function planes. The function planes include a resource plane 103 including physical resources, an enabler plane 102 corresponding to a resource function abstraction plane and a service plane 101 creating and delivering services.

The resources of the resource plane 103 include telecommunication sector physical resources 140 such as 2G telephone networks, mobile networks (IMS) and the Internet, information technology (IT) sector physical resources 141 such as web portals and social networks, and utility sector resources 142 such as knowledge engines. The functions of the resources 140, 141 and 142 correspond to enablers 131, 132, 133 and 134 of the media service platform 130 or components 135 and 136 constructing enablers.

The media service platform 130 represents abstraction of services and network resources of the telecommunication sector physical resources 140, the IT sector physical resources 141 and the utility resources 142 and uses the enablers 131, 132, 133 and 134 or the components 135 and 136 constructing enablers.

An enabler is a basic unit of the media service platform 100 and corresponds to a set of components. A component is a minimum unit of a function. The enablers or the components are connected through an SDP core bus 139 and are operatively connected with the resources through the SDP core bus 139. The enablers represent their functions through an adaptor corresponding to a standard application program interface (API) for operative connection with the SDP core bus 139 and communicate with the SDP core bus 139 through a standard interface. A web service interface can be used for the communication. An operation support system or a business support system among common elements required to execute services is supported as an enabler.

The media service platform 130 provides an I-centric enabler 180 as an enabler for supporting personalized services. The I-centric enabler 180 is an enabler generated by conceptualizing and objectifying ‘I’ such that I-centric services can be created using personal profiles or environment information. By using the I-centric enabler 180, ‘I’ can describe that I uses a device or moves a file from one device to another device as a service does in the real world.

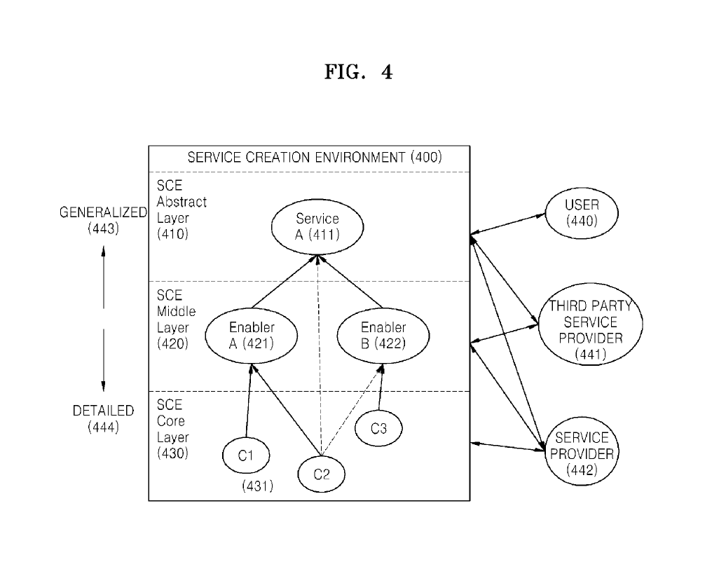

The service creation environment 110 includes service creation tools that allow a user 150, a third party service provider 160 and a service provider 170 to create new enablers or services using the enablers of the media service platform 130. The service creation environment 110 provides a graphic editor including a palette that provides components, enablers corresponding to sets of connected components and services corresponding to sets of connected components and enablers and software. The service creation environment 110 has a layered structure 111 in which the extent of a creatable service is determined for each user layer and includes a core layer accessed only by a service provider that owns a network to create components corresponding to minimum elements of a service, a middle layer accessed by a service provider and a third party service provider that provides services using network functions to create enablers using the components, and an abstraction layer accessed by a user and all the service providers to create services using the components and the enablers. The layered structure of the service creation environment 110 will be described later in more detail with reference to FIG. 4. The created enablers are delivered to the media service platform 130 and dynamically added to the enablers of the media service platform 130. The created services are stored in the service execution environment 120.

The service execution environment 120 stores the services described through the service creation environment 110 and executes a service in cooperation with the media service platform 130 when the service is requested to be used. The service execution environment 120 includes a service execution engine 121 executing services, a user profile 122 storing user profiles for executing I-centric services and a service repository 123 storing services. When a user requests the service execution environment 120 to execute a service, the user profile 122 stored for each person and each service is accessed to support a personalized service for each person and the service repository 123 is searched for the service requested by the user to execute the service through the service execution engine 121.

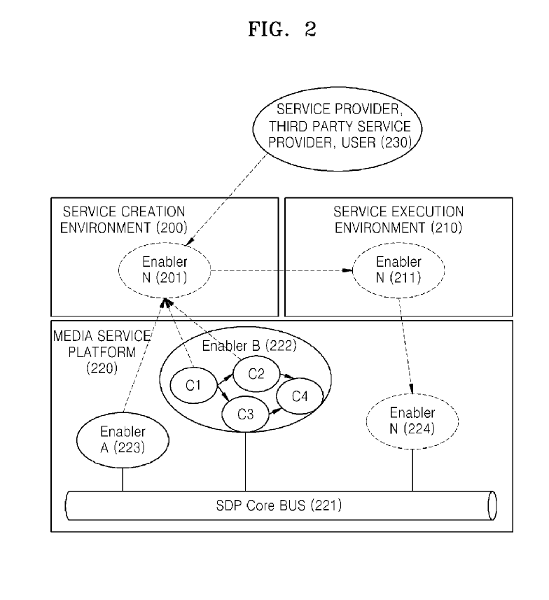

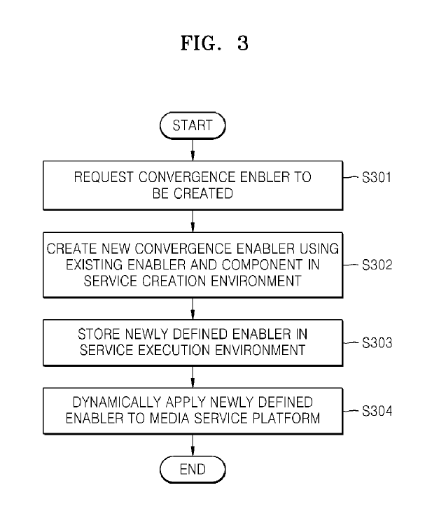

FIG. 2 illustrates a structure for describing a process of generating a new convergence enabler using enablers, according to an embodiment of the present invention and FIG. 3 is a flowchart illustrating the process of generating a new convergence enabler using enablers, according to an embodiment of the present invention.

Referring to FIGS. 2 and 3, a service creation subject 230 requests a new convergence enabler N 201 to be created through a service creation environment 200 in operation 5301. The service creation subject 230 may be a service provider, a third party service provider or a user.

The service creation subject 230 combines a previously defined enabler A 223 and components 1 and C2 among components C1, C2, C3 and C4 of a previously defined enabler B 222 to create and define the new convergence enabler N 201 in operation S302. The service creation subject 230 can create and define the new convergence enabler N 201 using an enabler newly defined through an enabler template together with the enabler and the components.

The new convergence enabler N 201 is stored in a service repository of a service execution environment 210 in operation 5303.

The new convergence enabler N201 stored in the service execution environment 210 is transferred to a media service platform 220 and connected with an SDP core bus 221 through a standard interface to be dynamically applied to the media service platform 220 in operation S304.

FIG. 4 illustrates a structure of a user-centric layered service creation environment 400 according to an embodiment of the present invention.

Referring to FIG. 4, the user-centric layered service creation environment 400 according to the embodiment of the present invention has three layers. Service elements become detailed 444 as function-centric services in a lower layer and generalized 443 as user-centric services in an upper layer. Subjects that can create services include a service provider 442, a third party service provider 441 and a user 440.

An SCE abstract layer 410 is for service description from a standpoint of a user and describes services based on a device (mobile handset, or the like) or a service (short message service (SMS), multimedia message service (MMS), or the like) that a user can easily meet and use.

A SCE middle layer 420 creates services based on enablers constructing services. For example, a set of an enabler A 421 and an enabler B 422 describes a service A 411.

The SCE core layer 430 creates services based on components constructing enablers. For example, a set of components C1 and C2 describes the enabler A 421 and a set of components C2 and C3 describes the enabler B 422.

The service provider 442 can make components, enablers and services using all the layers (SCE abstract layer, SCE middle layer and SCE core layer) of the service creation environment 400. The SCE core layer 430 describes components 431 corresponding to minimum units of abstracted network physical functions and can be created only by the service provider 442. This is an independent structure for controlling indiscreet access to network functions to improve system stability and providing business advantages to the service provider 442 that owns the platform.

A third party service provider 441 can create the enablers A 421 and B 422 and the service 411 using the SCE middle layer 420 and the SCE abstract layer 410 of the service creation environment 400. Enablers can be defined using previously defined enablers or components or newly defined using an enabler template. The third party service provider 441 is a subject that wants to create/deliver services using network functions to make a profit without owning a network. The network functions are provided by the service provider, in the form of an API by using the components 431 of the SCE core layer 430.

A user 440 can create a service using the SCE abstract layer 410 of the service creation environment 400. The service can be newly defined using a service template or defined using an existing service, enabler and component. An I-centric service that the user can personally participate in creating and correcting services using the SCE abstract layer can be provided.

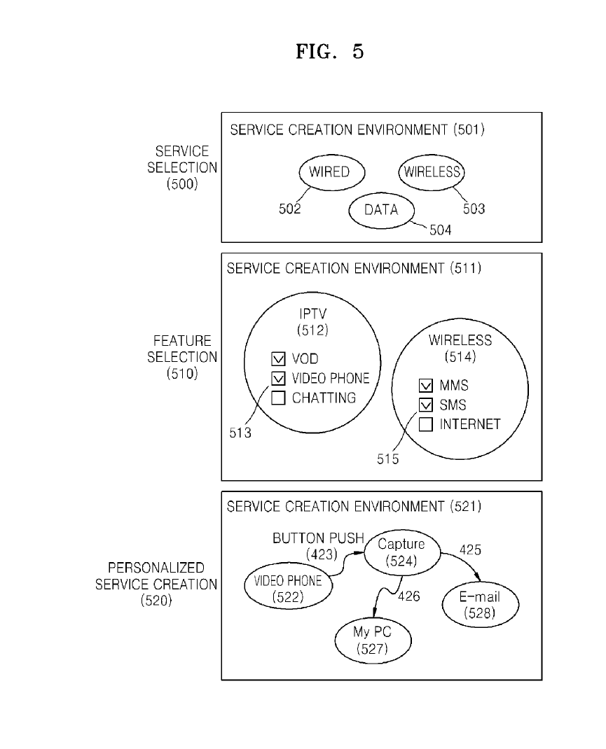

FIG. 5 illustrates I-centric services which can be provided by a service creation environment 501, according to an embodiment of the present invention.

Referring to FIG. 5, a user can perform service selection, feature selection and personalized service creation in the service creation environment 501.

The user can select a desired service in the service creation environment 501 (500). The user can select a wired service 502, a wireless service 503 or a data service 504 to create a personalized service. This corresponds to a case in which the user signs in services in a bundle for saving a charge without having relations with respective services, such as triple play service (TPS) and quadruple play service (QPS). Operations that should be performed on wired lines such as a telephone through an operator can be processed on-line according to an embodiment of the present invention.

The user can select a feature of each service in which the user signs (510). For example, an IPTV subscriber can interactively select desired VOD and video phone features from three features 513 of VOD, video phone and chatting provided by an IPTV service 512 on-line.

The user can define a service flow using a service in which the user signs, a standard function provided by features of the service and an interface to create a personalized service in a service creation environment 521 (520). If the user signs in services of a video phone 522, E-mail 528 and My PC 527, for example, the user can capture an image 524 using a button pushing function 423 of the video phone 522 when a video phone calls or while using the video phone and sends the captured image through the E-mail 528. When the user wants to store the captured image in My PC 527, the user can combine an enabler and a service corresponding thereto to create a personalized service specialized for the user.

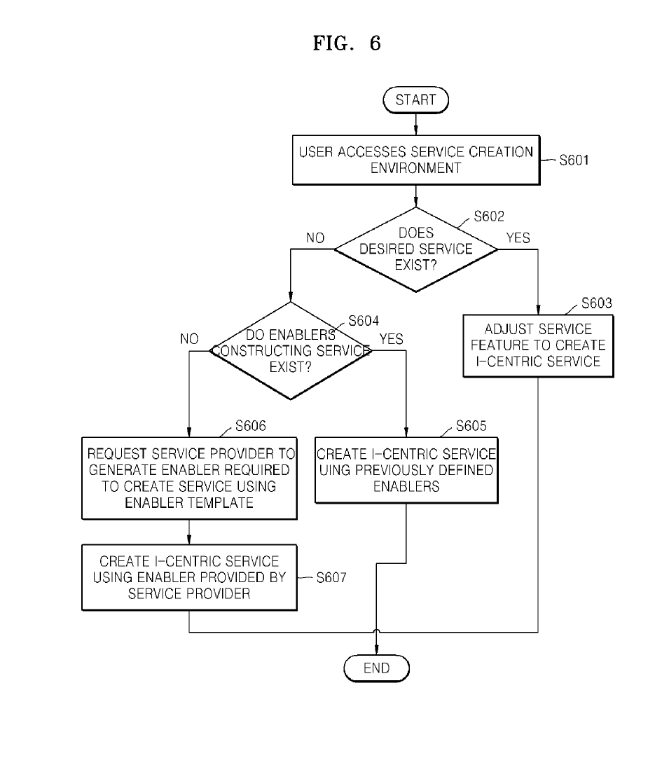

FIG. 6 is a flow chart illustrating a process of creating a personalized service according to an embodiment of the present invention.

A user who wants to create a personalized service accesses a SCE abstraction layer of a service creation environment in order to create the service in operation S601.

The user determines whether there is a desired service in the SCE abstraction layer in operation S602.

When the service exists, the user adjusts features of the service to create a personalized service and use the personalized service in operation S603.

When the service does not exist, the user determines whether enablers for creating the service exist in operation S604.

When the enablers exist, the user creates the personalized service using previously defined enablers in operation S605.

When the enablers constructing the service do not exist, the user requests a service provider to generate enablers required to create the service using the enabler template in operation S606.

When the service provider provides the enablers required to create the service, the user creates the personalized service using the provided enablers in operation S607.

The created service is loaded into a service execution environment to be executed. When the service is executed, the service registered in the service execution environment is searched and executed through a media service platform.

In alternative embodiments, hard-wired circuitry may be used in place of or in combination with processor/controller programmed with computer software instructions to implement the invention. Thus, embodiments of the invention are not limited to any specific combination of hardware circuitry and software.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for providing I-centric services using a service delivery platform, comprising:
a media service platform providing an enabler obtained by abstracting physical resources, an I-centric enabler obtained by abstracting a user, and a common interface of enablers;
a service creation environment layered according to service creating subjects and accessed by a user or a service provider to create services using the enabler; and
a service execution environment storing the created services and executing I-centric services based on a user profile in operative connection with the media service platform.

2. The apparatus of claim 1, wherein the service creation environment comprises:
a core layer accessed by only a service provider that is a network owner to create components corresponding to minimum elements of a service;
a middle layer accessed by the service provider and a third party service provider providing services using network functions to create enablers using the components; and
an abstract layer accessed by a user and all service providers to create services using the components and enablers.

3. The apparatus of claim 1, wherein the enabler is a set of connected components corresponding to minimum elements of a service.

4. The apparatus of claim 1, wherein the I-centric enabler is obtained by conceptualizing a user profile or environment information.

5. The apparatus of claim 1, wherein the service creation environment supports the user such that the user can select a service to create an I-centric service.

6. The apparatus of claim 1, wherein the service creation environment supports the user such that the user can select a service based on service features to create an I-centric service.

7. The apparatus of claim 1, wherein the service creation environment supports the user such that the user can create an I-centric service through connection of a service, a standard function provided by service features and an interface element.

8. The apparatus of claim 1, wherein a new enabler is created by the service creation environment, stored in the service execution environment, dynamically applied and added to the media service platform.

9. A method of creating an I-centric service using a service delivery platform, comprising:
accessing a service creation environment layered according to service creating subjects to create a service by a user;
requesting a service provider to create a new enabler when an enabler that is obtained by abstracting physical resources and constructs a service does not exist; and
creating the service using the new enabler.

10. The method of claim 9, wherein the service is created by a combination of an enabler and components constructing an enabler.

11. The method of claim 9, wherein the accessing of the service creation environment comprises accessing the uppermost layer in which a user describes a service using a previously defined enabler and components constructing an enabler in the service creation environment.

12. The method of claim 9, wherein the service provider comprises a network owner and a third party service provider providing services using network functions.

13. The method of claim 9, wherein the enabler comprises an I-centric enabler obtained by conceptualizing a user profile or user information.

14. A method of generating an enabler for creating an I-centric service, comprising:
combining a component corresponding to a minimum element of a service and an enabler corresponding to a set of connected components in a media service platform that provides the component and the enabler to create a new enabler; and
dynamically applying and adding the new enabler to the media service platform.

15. The method of claim 14, wherein the new enabler is created using a previously defined component, a previously defined enabler and an enabler newly defined using an enabler template.
